(19) United States
(12) Patent Application Publication
(10) Pub. No.: US 2008/0112169 A1
(43) Pub. Date: May 15, 2008

(54) Lighting system

(76) Inventor: Jeff R. Cunius, Ontario, CA (US)

Correspondence Address: LAW OFFICES OF NATAN EPSTEIN, 11377 WEST OLYMPIC BOULEVARD, TRIDENT CENTER - 9TH FLOOR, LOS ANGELES, CA, 90064, US

(21) Appl. No.: 11/600,015

(22) Filed: Nov. 14, 2006

(51) Int. Cl. F21V 21/14

(52) U.S. Cl. 362/250

(57) ABSTRACT

An electric lighting system for concealed lighting and track lighting installations has lamp holders spaced along a custom power cable with two finely braided high current conductors. The cable and conductors have a flattened rectangular cross section and are exceptionally pliable to facilitate cornering in tight spaces. The cable exterior is slotted for reduced height of the installed lamp holders and optimum low profile of concealed lighting installations. The lamp holders are adaptable to different types of lamps and include an optional reflector. Snap-on mounting lugs permit installation of the cable and lamp holders directly to a mounting surface. Alternatively, a low profile track holds the cable and lamp holders.

### BACKGROUND OF THE INVENTION

1. Field of the Invention

This invention pertains to the field of electric lighting and more specifically relates to a modular lighting system suitable for track mounting or trackless installation, for example, as concealed strip lighting in wall sconces and the like.

2. Background of the Invention

Track lighting and strip lighting is widely used, particularly in commercial settings, and many fixtures and modular systems of that type are available. Nonetheless, improvement is desirable in several aspects of those lighting systems.

### SUMMARY OF THE INVENTION

An electric lighting system is disclosed having a power distribution cable with two braided conductors covered in an electrically insulating jacket and lamp sockets spaced along the cable in electrical contact with the conductors for supplying electrical power to a lamp installed in each socket. The cable has a generally rectangular cable cross section with a cable width greater than the cable thickness.

The power cable has braided conductors each of generally rectangular conductor cross section, and the braided conductors are flat rope braided with multiple braids each having multiple strands. In a presently preferred cable each conductor has about seven braids of about twenty four strands each, and each of the two conductors is braided with about 168 strands of 0.005 inch diameter copper. The preferred cable width is approximately 0.6 inches and the cable height approximately 0.1 inches. The conductors have a conductor width of about 0.1350 inches and a conductor height of approximately 0.05 inch, the conductor width being parallel to the cable width and transverse to the cable height.

The insulation defines a cable top and a cable bottom and a longitudinal slot of generally rectangular cross section in each of the top and the bottom, such that the cable in cross section also resembles two rectangles with rounded corners joined along adjacent short sides by a narrow bridge. The insulation may be of relatively soft and pliable, self healing polyvinylchloride (PVC).

The cable is pliable such that it can be bent or folded tightly to make an L shaped corner bend for following corners while keeping the cable generally flat on either side of the corner. The L shape can be made by twisting the cable from a flat condition on either side of the corner from a flat condition through approximately a forty five degree angle to a make a corner fold. Alternatively an L turn can be made by folding the cable over itself along a diagonal fold line.

Each lamp socket has a socket top and a socket bottom adapted to make interlocking engagement with each other for capturing the cable therebetween. The socket top and the socket bottom each have a center ridge or boss shaped to mate into the longitudinal center slot in the cable top and the cable bottom respectively.

The socket bottom has two socket sides and the socket top is seated onto the socket bottom between the socket sides and is fastened thereto by interlocking portions integral to the socket top and the socket bottom. Lamp contacts supported on the socket top have piercing prongs projecting beneath the socket top for penetrating the insulating jacket and making electrical contact with the parallel conductors of the captive cable. Each piercing prong preferably penetrates the cable near the center of a corresponding one of the conductors. The lamp contacts are adapted and configured for receiving the opposite end contacts of a festoon type double ended tubular lamp with a lamp axis held between the lamp contacts in generally parallel relation to the power distribution cable. The socket top is molded of thermoplastic material with two integrally formed contact holders for receiving and supporting the lamp contacts.

A heat shield is retained to the socket top between the contact holders. The heat shield may be a metal plate retained by top prongs integral with the socket top. A light reflector, such as a parabolic light reflector, may be interchangeable with the heat shield on the socket top. The light reflector may be curved only in a direction transverse to the lamp socket and may be selectively weakened along break-away lines for facilitating separation of either of two reflector wings from a reflector center, the reflector center being retained to the socket top by the top prongs.

A mounting lug is adapted to make snap retentive engagement with each lamp socket, with a hole in the lug for passing a fastener such as a wood screw, such that each lamp socket can be secured to a mounting surface, such as a wall or ceiling, by the fastener passing through the hole in a corresponding lug.

The lamp contacts on each lamp socket are configured for receiving a festoon type lamp with festoon contacts at opposite ends of a generally cylindrical lamp body. An adapter is provided for installing in the festoon lamp socket an MR type lamp having parallel pin contacts extending from a lamp base. The adapter has a frame having a longitudinal axis and a transverse axis, the frame being supported along its longitudinal axis between a pair of festoon contacts, a lamp holder on the frame, a pair of conductive clip inserts fitted in clip receptacles defined in the lamp holder, pin holes in the lamp holder communicating the clip receptacles to a lamp seat surface on the lamp holder such that lamp pins inserted in the pin holes come into electrical contact with the clip inserts, the clip inserts supporting the lamp holder to the frame for pivotal movement about the transverse axis, and electrical connectors on the frame for interconnecting each clip insert to a corresponding one of the festoon contacts, such that electrical power is provided from the festoon contacts to lamp pins inserted in the pin holes. Preferably, the clip inserts are pivotable about a first pair of conductive rivets supported on the frame, the festoon contacts are fastened to the frame by a second pair of conductive rivets, and the electrical conductors comprise conductive strips between the first rivets and the second rivets. The lamp holder may be generally tubular and the clip receptacles are opposite ends of a bore through the lamp holder.

The adapter can be provided with a centrally apertured dished light shield having a rearwardly extending axial collar about its central aperture. A generally U-shaped clip is fitted about the lamp holder and has clip ends in releasable retentive engagement with the collar for attaching the collar to the lamp holder, such that a lamp may be inserted through the collar into the pin holes of the adapter without separating the shield from the lamp holder. The collar may be integrally formed with the dished light shield with diametrically opposed openings stamped out in the collar for admitting the clip ends of the clip into retentive engagement with the collar.

An end cap is provided for terminating and supporting an end of the power distribution cable. The end cap has a cap top and a cap bottom assembled to each other in releasable interlocking engagement for capturing therebetween the end of the cable. The cap top and cap bottom each have longitudinal center ridges or bosses configured to mate into the longitudinal center slot in the cable top and the cable bottom respectively. The cap bottom has cap bottom side walls and the cap top is seated on the cap bottom between the cap bottom side walls and is fastened thereto by interlocking portions integral to the cap top and the cap bottom. The interlocking portions may include tabs on the cap top engageable in corresponding tab slots defined in the cap bottom. Preferably, the cap top and the cap bottom each have three side walls and an open side, the three side walls of the cap top are received between the three side walls of the cap bottom in the assembled condition of the end cap with the cable end captive therebetween. A mounting lug is adapted to make snap retentive engagement with the end cap, preferably with the cap bottom, such that the end cap may be fastened to a mounting surface by a fastener passing through a hole in the lug. The mounting lug may have lug prongs engageable in a slot defined in the cap bottom for making snap retentive engagement with the end cap. The same mounting lugs may be used for mounting both the lamp sockets and the end cap.

Mounting clips are provided for supporting the power cable to a mounting surface at locations spaced from lamp sockets. The mounting clip has a clip plate with a contact side for placement against a mounting surface, at least one and preferably two clip arms on an opposite side of the clip plate, and a hole for passing a mounting fastener through the plate. A contact adhesive may be provided on the contact side of the plate, for example for holding the mounting clip on the mounting surface while a fastener is installed through the plate.

As an alternative to use of mounting lugs or mounting clips to hold the cable and attached sockets to a mounting surface, a track is provided with two track side walls and a track bottom. The track is attached to a mounting surface with track fasteners such as screws passing through holes spaced along the track bottom. The track receives the power cable and interlocks with lamp sockets inserted between the track side walls. A side ridge along each side wall of the track fits into side grooves formed in each lamp socket to make snap retentive engagement for holding the lamp socket in the track. The track may be an extrusion of plastic or other suitable material, and a translucent or transparent lens such as a prismatic lens can be installed over the track as by snap interlock with the sides of the track.

In one form of the invention a wire guide is provided on an outer side of each of the track side walls for guiding additional single conductor insulated electrical wires along the sides of the track. The wire guides may be integral with the track, for example, extruded integrally with the track. The wire guides are each shaped for holding captive an electrical wire against a mounting surface underlying the track bottom.

These and other features, improvements and advantages of the present invention will be better understood by reference to the following detailed description of the preferred embodiments and the accompanying drawings.

### BRIEF DESCRIPTION OF THE DRAWINGS

FIG. 1 shows in perspective view a length of strip lighting according to this invention with the power cable bent to make an L shaped turn;

FIG. 1A shows a typical concealed lighting installation using the strip light of FIG. 1;

FIG. 1B shows a strip lighting section as in FIG. 1 but with the power cable folded over itself to make an L turn;

FIG. 1C is an enlarged fragmentary view of the bend in the power cable of FIG. 1;

FIG. 1D is an enlarged fragmentary view of the fold in the power cable of FIG. 1B;

FIG. 2 is a cross section of the power cable of the strip lighting of FIGS. 1 and 1B;

FIG. 3 is a perspective view of a festoon type lamp socket with assembled mounting lug and screw fastener;

FIG. 4 is an exploded view of the lamp socket, mounting lug and screw fastener of FIG. 3;

FIG. 5 is an end view of the lamp socket of FIG. 3 shown installed on the power cable, the latter suggested in phantom lining;

FIG. 6 is a perspective view of the festoon type lamp socket with assembled mounting lug and screw fastener of FIG. 3 shown installed on the power cable;

FIG. 7 shows the lamp socket as in FIG. 3 with a parabolic light reflector in exploded relationship to the socket as a replacement for the heat shield plate in FIG. 3;

FIG. 8 is a top plan view of the parabolic light reflector of FIG. 7 with the two break-away lines suggested in dotted lining;

FIG. 8A is an end view of the parabolic light reflector of FIG. 7;

FIG. 8B is an end view of the parabolic light reflector of FIG. 7 with one wing of the reflector broken away;

FIG. 9 is a view as in FIG. 7 but showing the parabolic reflector installed on the lamp socket and the lamp socket installed on the power cable;

FIG. 10 shows the festoon type lamp socket as in FIG. 7 and, in exploded relationship, an MR lamp adapter with light shield for the festoon lamp socket;

FIG. 11 is a view as in FIG. 10 showing the MR lamp adapter installed on the festoon type lamp socket;

FIG. 12 is an exploded perspective view of the light shield and its retaining clip with the MR lamp adapter;

FIG. 13 is a perspective view of the MR lamp adapter of FIG. 10;

FIG. 14 is an exploded perspective view of the MR lamp adapter of FIG. 13;

FIG. 15 is a perspective view of the cable mounting clip according to this invention:

FIG. 16 is a perspective view showing the cable mounting clip of FIG. 15 holding the power cable;

FIG. 17 is a perspective view of the end cap installed for terminating an end of the power cable and assembled to a mounting lug and screw fastener;

FIG. 18 is an exploded perspective view of the end cap, mounting lug and screw fastener of FIG. 17;

FIG. 19 is a perspective view of a terminal strip block for connecting the power cable to a pair of electrical supply wires;

FIG. 20 is a view as in FIG. 19 showing the cover of the terminal strip block open for access to the terminal strip screws;

FIG. 21 is an exploded view of the terminal strip block of FIG. 19;

FIG. 22 is a perspective view of a junction box :assembled to an end of the power cable for splicing the power cable to a pair of electrical supply wires;

FIG. 23 is an exploded view of the junction box of FIG. 22;

FIG. 24 is a perspective view of a junction box assembled to two cable ends for making an L splice between the cable ends;

FIG. 25 is an exploded view of the junction box of FIG. 24;

FIG. 26 is an exploded cross sectional view of a festoon lamp socket, track section and lens;

FIG. 27 Is an assembled perspective view of a track section with assembled lens and housing a length of strip lighting consisting of a power cable with lamp sockets installed on the cable at regular intervals;

FIG. 28 is an assembled cross sectional view of the festoon lamp socket, track section and lens of FIG. 26;

FIG. 29 is an exploded cross sectional view of a festoon lamp socket, wall wash type track section and lens;

FIG. 30 is an assembled perspective view of the wall wash track section with assembled lens and housing a length of strip lighting consisting of a power cable with lamp sockets installed on the cable at regular intervals;

FIG. 31 is an assembled cross sectional view of the festoon lamp socket, wall wash track section and lens of FIG. 29;

FIG. 32 is an exploded cross sectional view of a festoon lamp socket, chaser type track section and lens;

FIG. 33 is an assembled perspective view of the chaser type track section with assembled lens and housing a length of strip lighting consisting of a power cable with lamp sockets installed on the cable at regular intervals, and showing chaser wires along the outer sides of the track;

FIG. 34 is an assembled cross sectional view of the festoon lamp socket, chaser type track section with chaser wires and lens of FIG. 32;

### DETAILED DESCRIPTION OF THE PREFERRED EMBODIMENTS

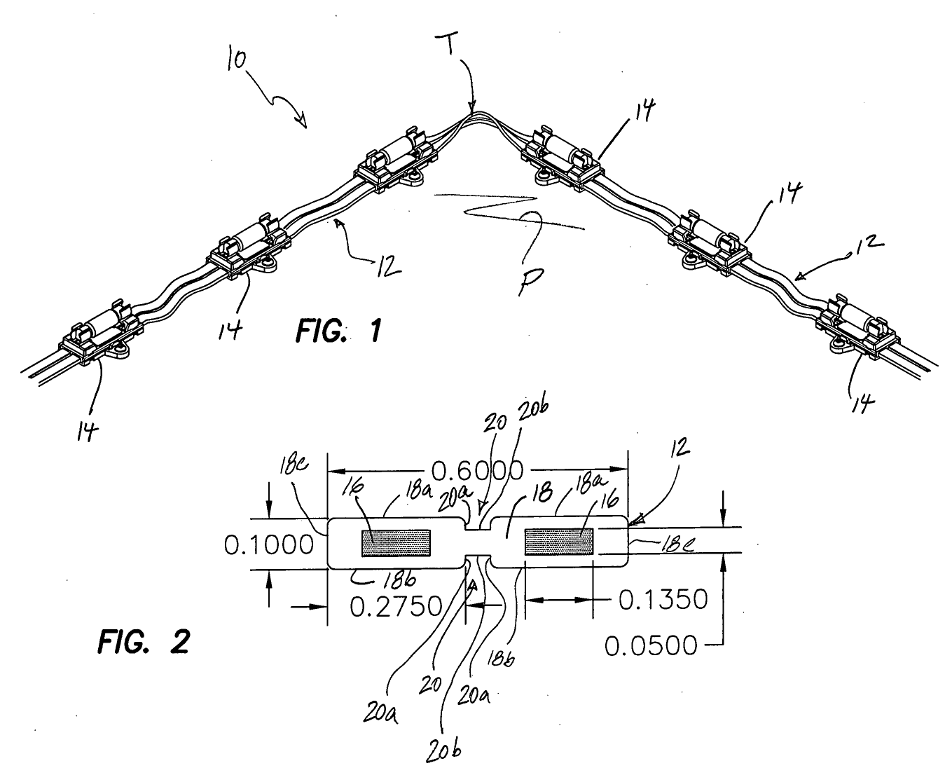

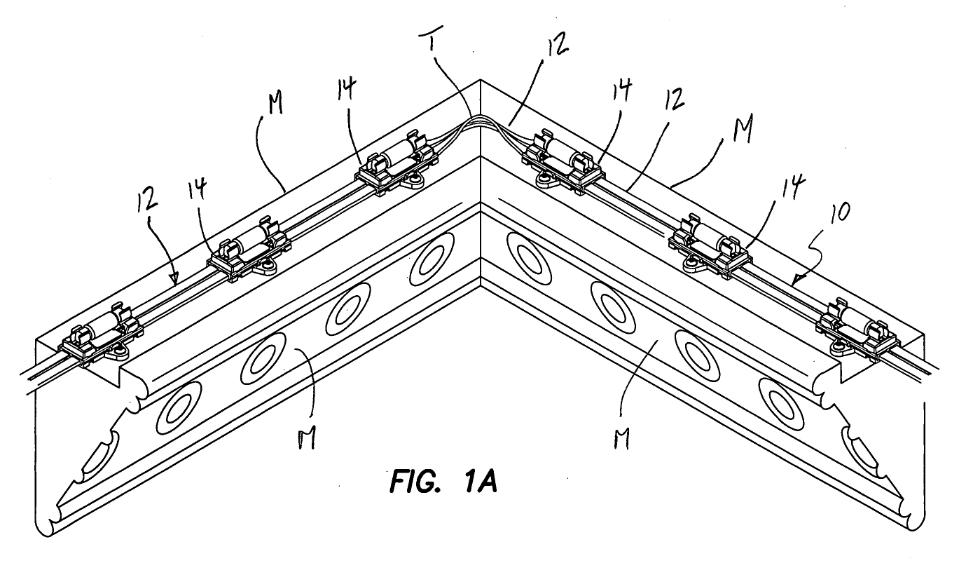

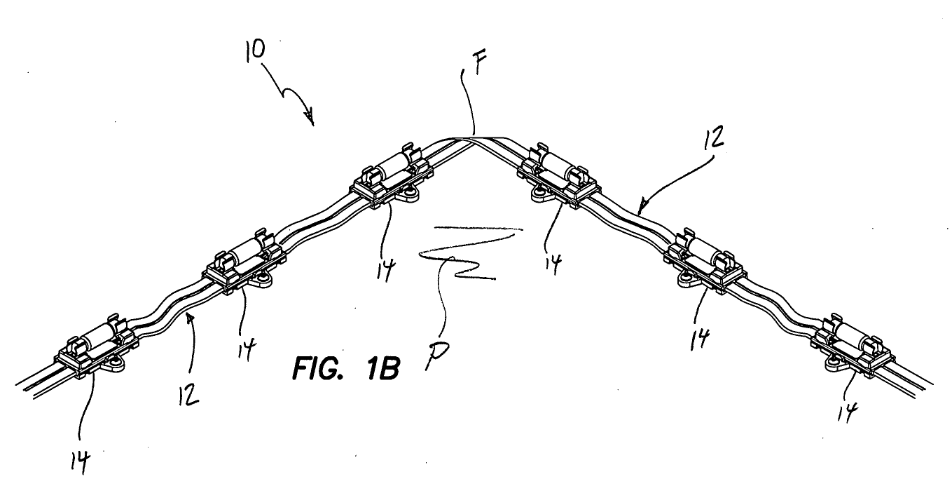

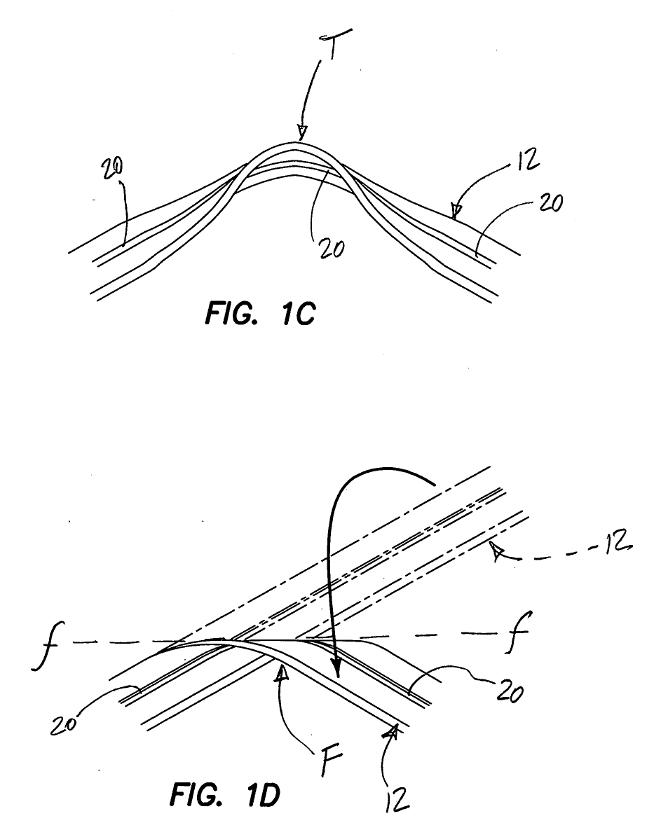

With reference to the drawings wherein like elements are designated by like numerals, FIG. 1 shows a length of strip lighting generally designated by numeral 10 which has an electrical power distribution cable 12 and lamp sockets 14 spaced at regular intervals along cable 12.

FIG. 2 shows a cross section of the power cable 12, with two parallel electrical conductors 16 covered in electrical insulation 18. The cable insulation 18 is generally rectangular in cross section with a cable top 18a, a cable bottom 18b and two cable sides 18c. The cable top and cable bottom are planar and parallel to each other and are each divided by a longitudinal center slot 20. Slots 20 have a generally rectangular cross section with two slot walls 20a perpendicular to a slot bottom 20b. FIG. 2 shows the presently preferred dimensions of the power cable 20, with a small cable height of 0.1 inch relative to a greater width of 0.6 inch, yielding a relatively large width to height ratio. The insulation 18 has a minimum thickness of about 0.05 inch as measured between the bottoms 20b of the upper and lower slots 20, a slot depth of 0.025 inch and a slot width of 0.05 inch between slot walls 20a. The insulation is made of a relatively soft grade of polyvinylchloride, selected to be self healing when pierced.

The conductors 16 are rectangular in cross section. The preferred braiding is a flat rope braid using 0.005 inch diameter copper strands: with seven braids of twenty four strands each, such that each conductor 16 is braided with about 168 strands. The resulting stranded conductor is gauge equivalent to AWG 14. The braided conductors are hammered to the rectangular cross section from an initial round cross section of the rope braiding, and then covered with insulation 18. The conductors 16 have a conductor width of 0.1350 inch and a conductor height of 0.05 inch, as indicated in FIG. 2 of the drawings.

The resulting power cable 12 is pliable to a substantially greater degree than other power cable of comparable capacity used until now in strip lighting, and particularly more pliable than twin conductor cord having round insulation about each conductor. The power cable 12 can be easily bent to make relatively tight small radius corner turns and folds.

FIG. 1 shows cable 12 bent into a right angle turn or L shaped turn, designated by the letter “T”, over a relatively short length of cable 12 between two adjacent lamp sockets 14. Significantly, the cable 12 under each of the sockets 14 immediately adjacent to the turn T lies flat on an underlying mounting surface. This is important since each socket is fastened to the mounting surface as will be explained below. Also, the short length of cable 12 required for making the turn T is significant because the strip lighting 10 is in part sold in prefabricated lengths of cable with lamp sockets 14 installed on the cable 12 at regular intervals, such as 3 inch, 6 inch and 10 inch spacing between sockets 14. Since the sockets are all pre-installed on one side of the cable 12, the same side of the cable must be flat against the common mounting surface on either side of the turn T, and as the available length of cable 12 between the adjacent sockets 14 can be small, the pliability of cable 12 facilitates installation of the strip lighting 10. In conventional strip lighting using heavy gauge round power cord it is frequently necessary to cut and splice the power cord to make tight turns because the cord cannot be bent or folded to a sufficient degree.

In FIG. 1 the L shaped turn T is made by twisting the cable 12, from an initially flat condition on an underlying supporting plane P supporting the cable 12 and lamp sockets 14, through about a 45 degree twist along the cable on each side of the turn so as to form a relatively sharp bend B with an imaginary bend line b-b across the cable 12, so that the bend line lies at approximately a 45 degree angle to the plane P of the initially flat cable 12, as best seen in FIG. 1C. This type of turn or bend T is suitable for the prefabricated strip lighting 10 because all sockets 14 are preinstalled on one side of the cable 12 and the same side of the cable stays up on each side of the turn

FIG. 1A illustrates how the tight turn T of the strip lighting 10 benefits a concealed lighting installation recessed in a narrow cove molding M.

FIG. 1B shows a right angle turn or L shaped fold, designated by the letter “F”, made by folding cable 12 over itself along a diagonal fold line f-f as best seen in FIG. 1D. This kind of cable fold is useful in cases where the cable 12 and lamp sockets 14 are purchased “loose” by an end user and the fold line f-f can be located along the cable before the lamp sockets 14 are assembled to the cable, so that sockets can be mounted on different upper facing sides of the cable 12 on each side of the fold F.

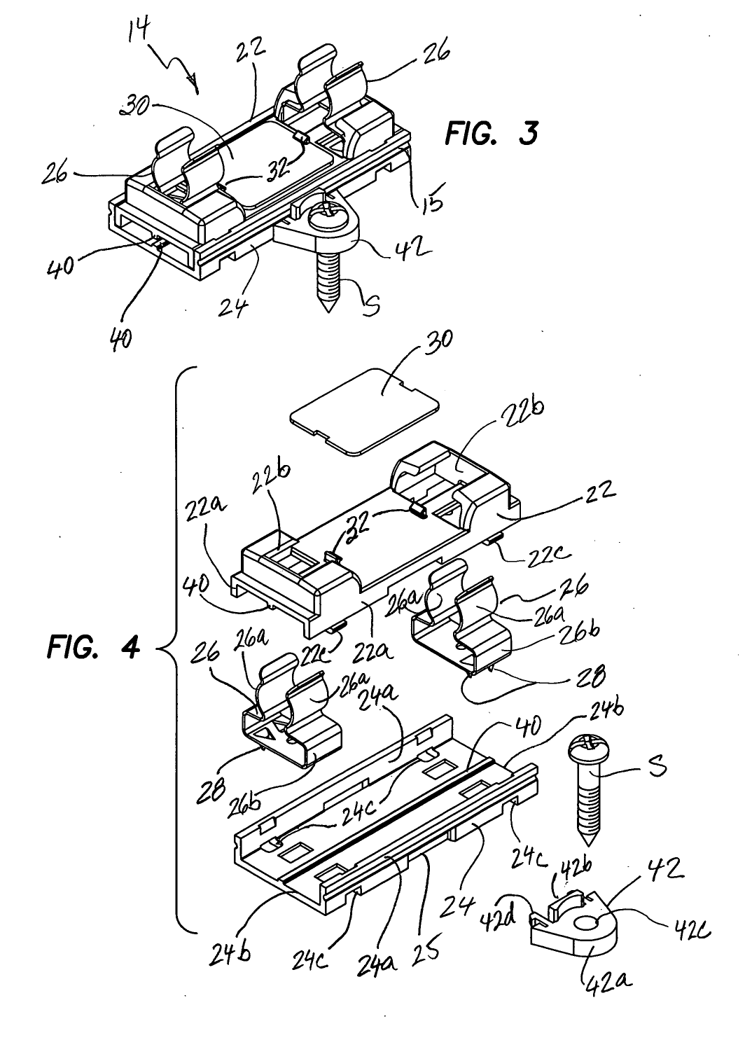

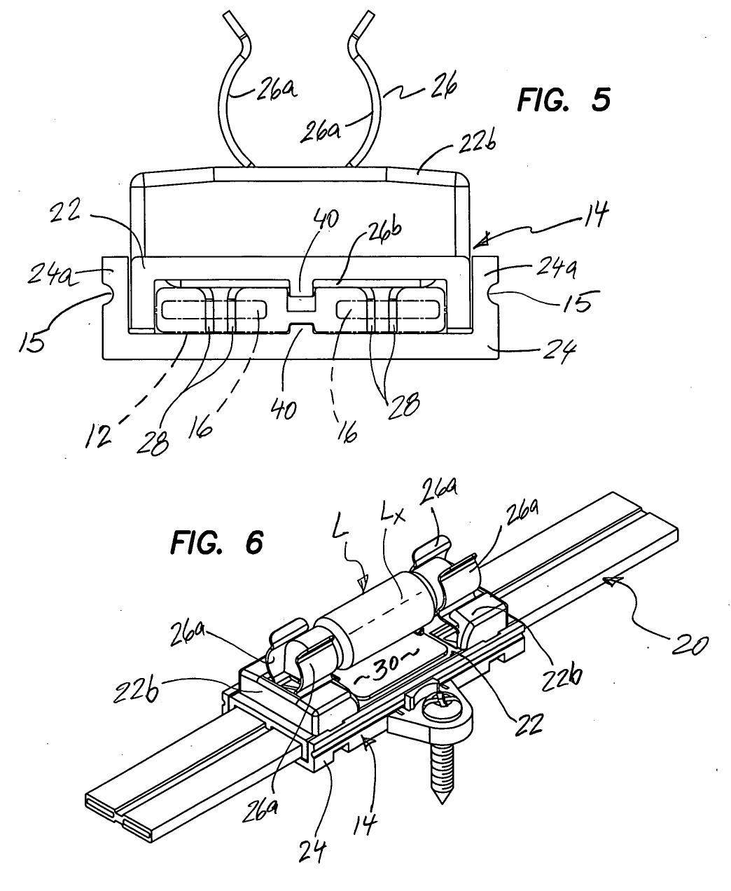

FIGS. 3 and 4 show a lamp socket 14 having a socket top 22 and a socket bottom 24 adapted to make interlocking engagement with each other for capturing the cable 12 therebetween, and lamp contacts 26 supported on the socket top 22 and which terminate in piercing prongs 28 projecting beneath the socket top. The piercing prongs 28 penetrate the cable insulation 18 of the captive cable 12 as best seen in FIG. 5 and make electrical contact with the parallel conductors 16, each piercing prong 28 preferably penetrating near the center of a corresponding one of the conductors 16. The conductors 16 are formed with a width greater than their height, as previously explained, to provide a greater piercing area to the piercing prongs 28. The socket top 22 and the socket bottom 24 each have a center ridge 40 or boss shaped to mate into the longitudinal center slot 20 in the cable top 18a and the cable bottom 18b, respectively, to help position the cable 12 in relation to the piercing prongs 28 and ensure electrical contact by the piercing prongs with conductors 16. The socket bottom 24 has two socket bottom side walls 24a and two open ends 24b. The socket top 22 has two socket top side walls 22a and is seated on the socket bottom 24 between the side walls 24a. The socket top is fastened to the socket bottom by interlocking portions 22c, 24c integral to the socket top and the socket bottom, respectively, namely, tabs 22c configured to snap into tab openings 24c.

The lamp contacts 26 are adapted and configured for receiving the opposite end contacts Lc of a conventional festoon type double ended lamp L held of tubular configuration with a lamp axis Lx generally parallel to the power distribution cable 20, as shown in FIG. 6. The socket top 22 is molded of thermoplastic material with two integrally formed contact holders 22b for receiving and supporting the lamp contacts 26 with contact arms 26a projecting upwardly from the socket top and contact base 26b captive under the socket top 22 in contact holder 22b. A heat shield 30 is retained to the socket top 22 between the contact holders 22b under the central light emitting portion of the festoon: lamp L. The central portion of the lamp L typically becomes hottest and shield plate 30 protects the thermoplastic material of socket top 22 against excessive heating by dissipating heat over a larger area. The heat shield 30 may be a metal plate retained by top prongs 32 integral with the socket top 22.

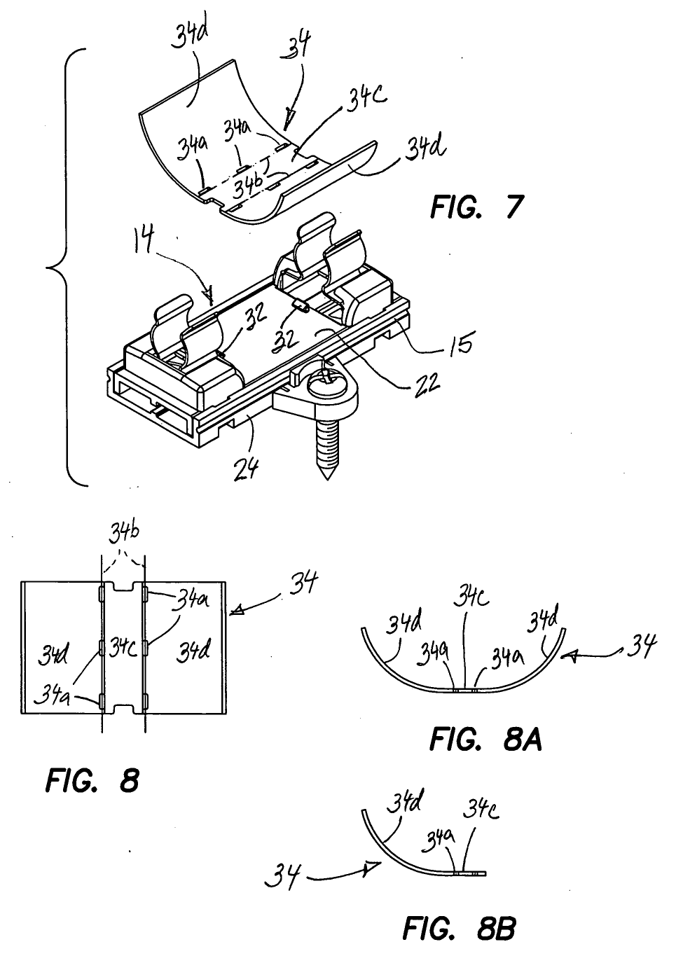

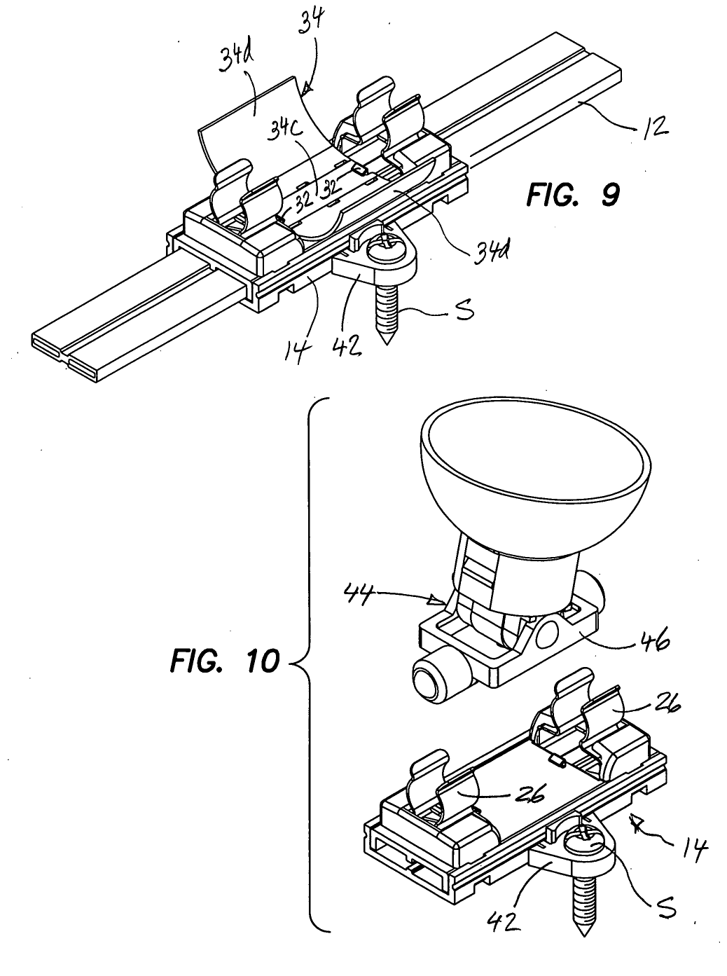

A light reflector, such as a parabolic light reflector 34 seen in FIGS. 7-8B, may be interchangeable with the heat shield 30 on the socket top. The light reflector 34 is flat in a longitudinal direction and is curved only in a direction transverse to the lamp socket 14. A series of rectangular holes 34a are punched in the reflector to selectively weaken the reflector along imaginary break-away lines 34b for facilitating separation of either of two reflector wings 34d from a reflector center 34c, the reflector center 34c being retained to the socket top 22 by the top prongs 32 in a manner analogous to retention of the heat shield plate 30 depicted in FIG. 3. Reflector 34 with both wings 34d generally directs light from lamp L in a beam away from the reflector center. FIG. 8B shows reflector 34 with one reflector wing 34d broken away from reflector center 34c resulting in more light being directed to one side of lamp L away from the remaining reflector wing 34d.

A mounting lug 42 is adapted to make snap retentive engagement with each lamp socket 14, as seen in FIGS. 3 and 4. Lug 42 is ear shaped with a rounded outer edge 42a, a flat inner edge 42b and a hole 42c through the lug for passing a fastener such as a wood screw S through the hole, such that each lamp socket 14 can be individually fastened to a mounting surface. Each lug 42 holds down a corresponding lamp socket 14 and the lugs collectively also support cable 12 running through the sockets 14.

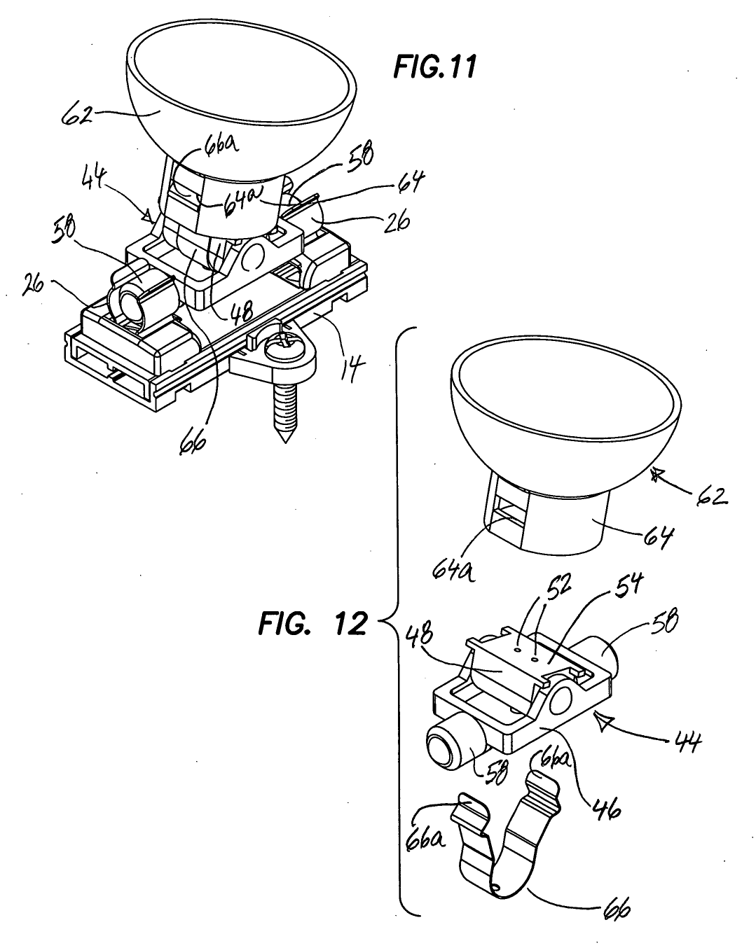

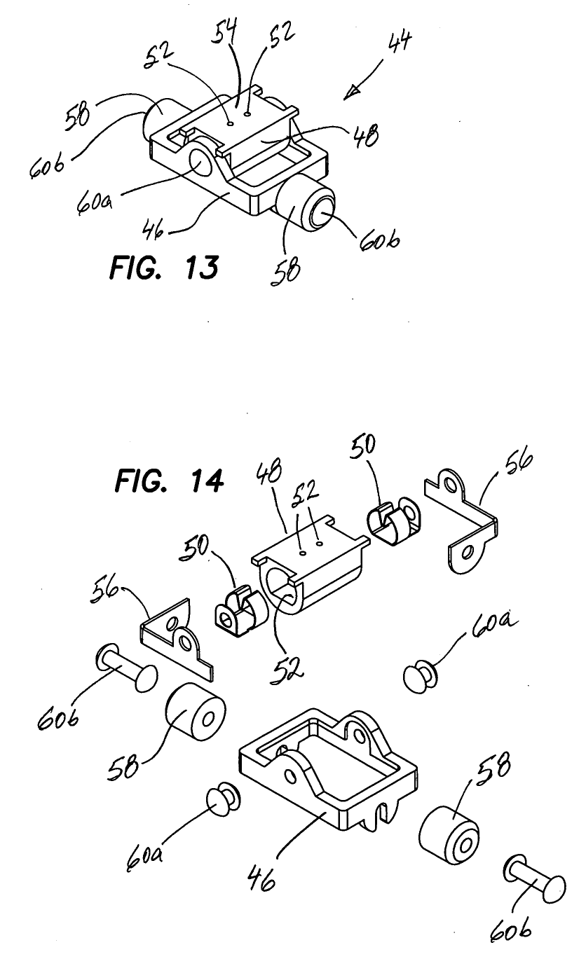

The lamp contacts 26 on each lamp socket 14 are configured for receiving a festoon type lamp L which is a conventional lamp configuration characterized by a tubular overall shape with cylindrical metal contacts at opposite ends of a generally cylindrical glass body. In order to enable use of lamps other than festoon lamps in the lighting system 10, an adapter 44 is provided for installing an MR type lamp, also a conventional lamp configuration having parallel pin contacts extending from a lamp base. As seen in FIGS. 10-14 the adapter 44 has a frame 46 with a longitudinal axis and a transverse axis. Frame 46 is held between the festoon lamp contacts 26 of the lamp socket 14 along its longitudinal axis. Frame 46 supports a lamp holder 48 and a pair of conductive clip inserts 50 fitted in clip receptacles 52 defined in the lamp holder 48. Two pin holes 52 in the lamp holder 48 are open between and communicate the clip receptacles 52 to a lamp seat surface 54 on the lamp holder 48, such that lamp pins of an MR type bulb inserted in the pin holes 52 come into electrical contact with one end of the clip inserts 50. The clip inserts 50 serve as bearings to support the lamp holder 48 to frame 46 for pivotal movement about the transverse axis of the frame, and electrical connectors 56 are provided on the frame 46 for interconnecting each clip insert 50 to a corresponding one of the adapter's festoon contacts 58, such that electrical power is provided from the festoon contacts 58 to lamp pins inserted in the pin holes 52. The clip inserts 50 are pivotable about a first pair of conductive rivets 60a supported on the frame 46, the adapter festoon contacts 58 are fastened to the frame 46 by a second pair of conductive rivets 60b, and the electrical conductors 56 are conductive strips in connected by electrical contact between the first rivets 60a and the second rivets 60b. The lamp holder 48 is generally tubular with a flat lamp seat surface 54, and the clip receptacles 52 are opposite ends of a bore passing through the lamp holder 48.

The adapter 44 can be provided with a centrally apertured dished light shield 62, for example, an aluminum spinning with a rearwardly extending axial collar 64 about its central aperture. A generally U-shaped retaining clip 66 fits about lamp holder 48 and has clip ends 66a which make releasable retentive engagement with the collar 64 for holding the collar 64 to the lamp holder 48, such that the base of an MR type lamp may be inserted through the collar 64 onto the lamp seat surface 54 and the lamp pins inserted into pin holes 52 without separating the light shield 62 from the lamp holder 48. The collar 64 may be integrally formed with the light shield 62 and with diametrically opposed openings 64a stamped out in the collar 64 for admitting the clip ends 66a into the aforementioned retentive engagement.

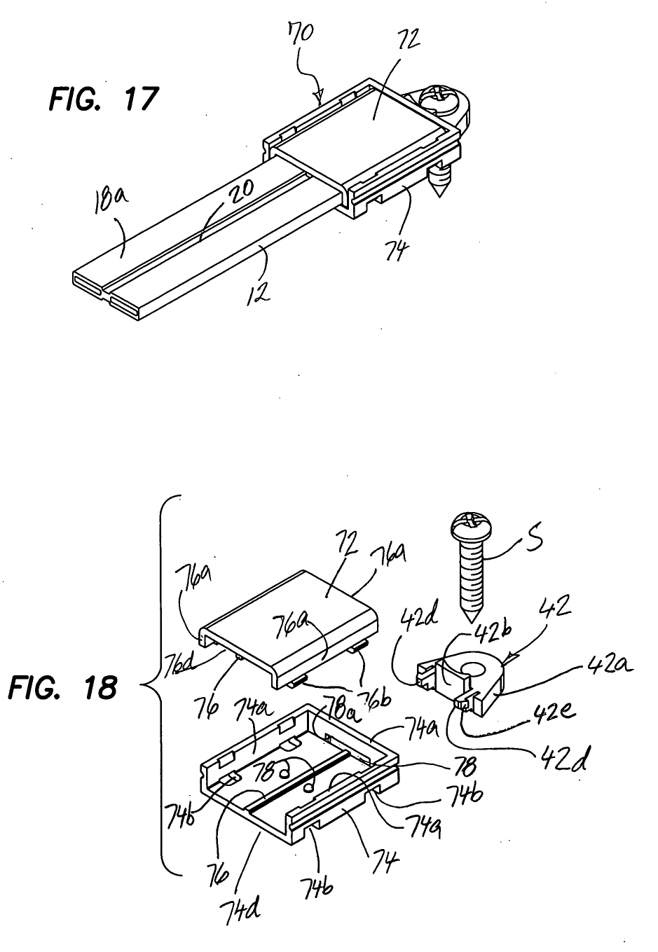

An end cap 70 shown in FIGS. 17 and 18 is provided for supporting and terminating an end of the power distribution cable 12. The end cap 70 has a cap top 72 and a cap bottom 74 assembled to each other in releasable interlocking engagement or snap lock assembly for capturing between them an end of the power distribution cable 12. The cap top 72 and cap bottom 74 each have a longitudinal center ridge 76 or boss configured to mate into the longitudinal center slot 20 in the cable top 1 Ba and the cable bottom 1 8b respectively.

The cap bottom 74 has two cap bottom sides 74a and the cap top 76 is seated onto the cap bottom 74 between the cap bottom sides 74a and is fastened thereto by interlocking portions integral to the cap top and the cap bottom. The interlocking portions may include tabs 76b on the cap top 76 engageable in corresponding tab slots 74b defined in the cap bottom 74. Preferably, the cap top 76 and the cap bottom 74 each have three sides 76a, 74a respectively and an open side 76d, 74d, respectively. The three sides 76a of the cap top 76 are received between the three sides 74a of the cap bottom 74 in the assembled condition of the end cap 72 shown in FIG. 17. The cable 12 enters the end cap 72 through the aligned open sides 76d, 74d. Raised bumps 78 on cap top and bottom press into the resilient insulation 18 of cable 12 and keep the cable end from being easily pulled out of the end cap 72.

A mounting lug 42 identical to the lug 42 used for mounting lamp sockets 14 above is adapted to make snap retentive engagement with the end cap 72 such that the end cap may be secured to a mounting surface by a fastener, such as wood screw S, passing through hole 42c in the lug. The lug 42 has two barbed lug prongs 42d engageable in a slot 78 defined in the cap bottom 74 for making snap retentive engagement with the assembled end cap 72. The lug prongs have cam surfaces 42e which are squeezed together by side edges 78a of the slot 78 when the prongs are pressed into the slot and then spring away from each other inside the cap 72 holding the lug 42 against the side 74a of the cap bottom. Engagement of lug 42 to lamp socket 14 is similar by engaging lug 42 In slot 25 provided in socket bottom 24.

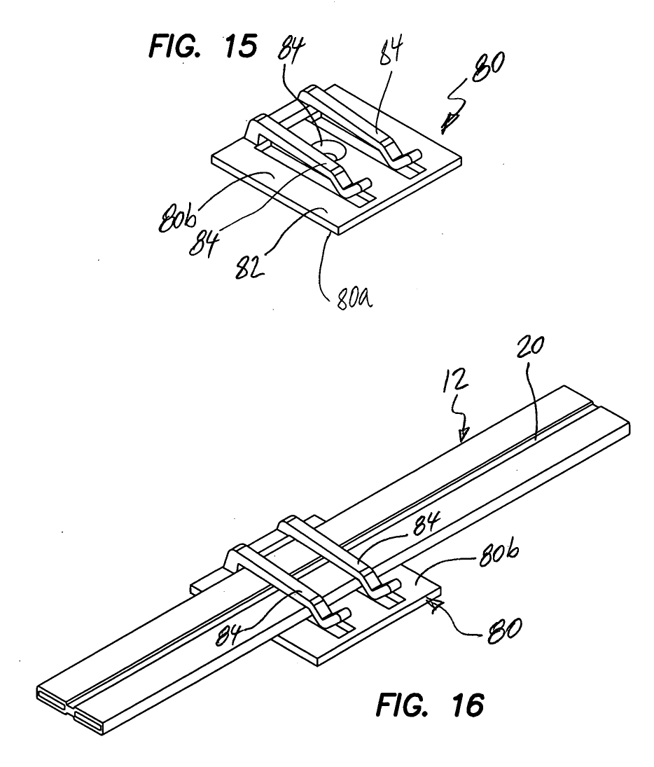

One or more mounting clips 80 shown in FIGS. 15 and 16 may be provided for supporting the power distribution cable 12 to a mounting surface where support may be needed, for example at locations away from lamp sockets 14. The mounting clip 80 has a clip plate 82 having a contact side 80a for placement against a mounting surface, two clip arms 84 on an opposite side 80b of the clip plate, and a hole 84 for passing a mounting fastener such as a wood screw through the plate 82. A contact adhesive may be provided on the contact side 80a of the plate 82, to facilitate installation by holding the clip 80 on the mounting surface while a fastener is installed through the plate 82.

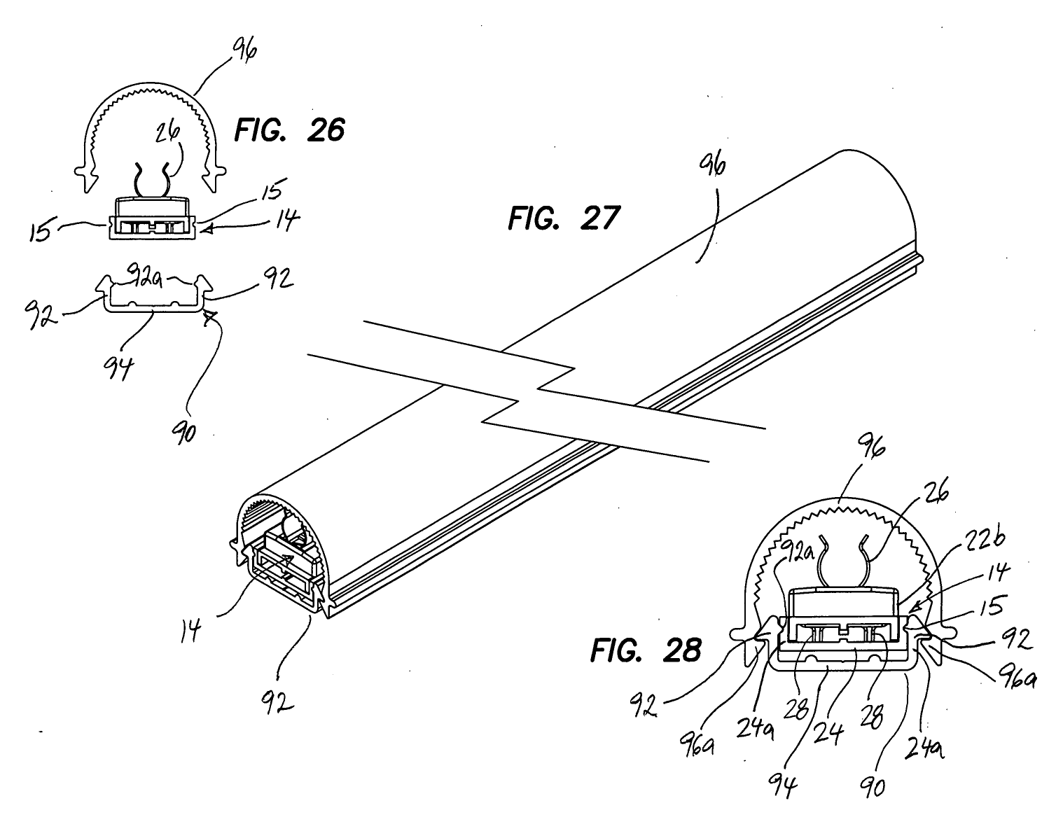

The strip lighting system 10 as described to this point makes use of mounting lugs 42 and possibly mounting clips 80 for fastening the cable 10 and lamp sockets 14 to a mounting surface. As an alternative, a track 90 is provided which can be fastened to a mounting surface for holding cable 12 and lamp sockets 14, as shown in FIGS. 26-28.

Turning to FIGS. 26-28 track 90 has two track side walls 92 and a-track bottom 94, and is attached to a mounting surface with track fasteners such as screws passing through holes spaced along the track bottom. Track 90 interlocks with and retains lamp sockets 14 inserted between the track side walls 92. A side ridge 92a along the interior of each track side wall mates with side grooves 15 formed on the outside of socket bottom side walls 24a, as best seen in FIG. 28. The lamp socket 14 makes snap retentive engagement in track 90 when pressed down into the track, to hold the lamp socket in the track. The track may be a continuous extrusion of plastic or other suitable material. A translucent or transparent lens 96 can be installed over the track 90, for example, also by snap interlocking of the lens edges 96a with the sides 92 of the track, as shown in FIG. 28.

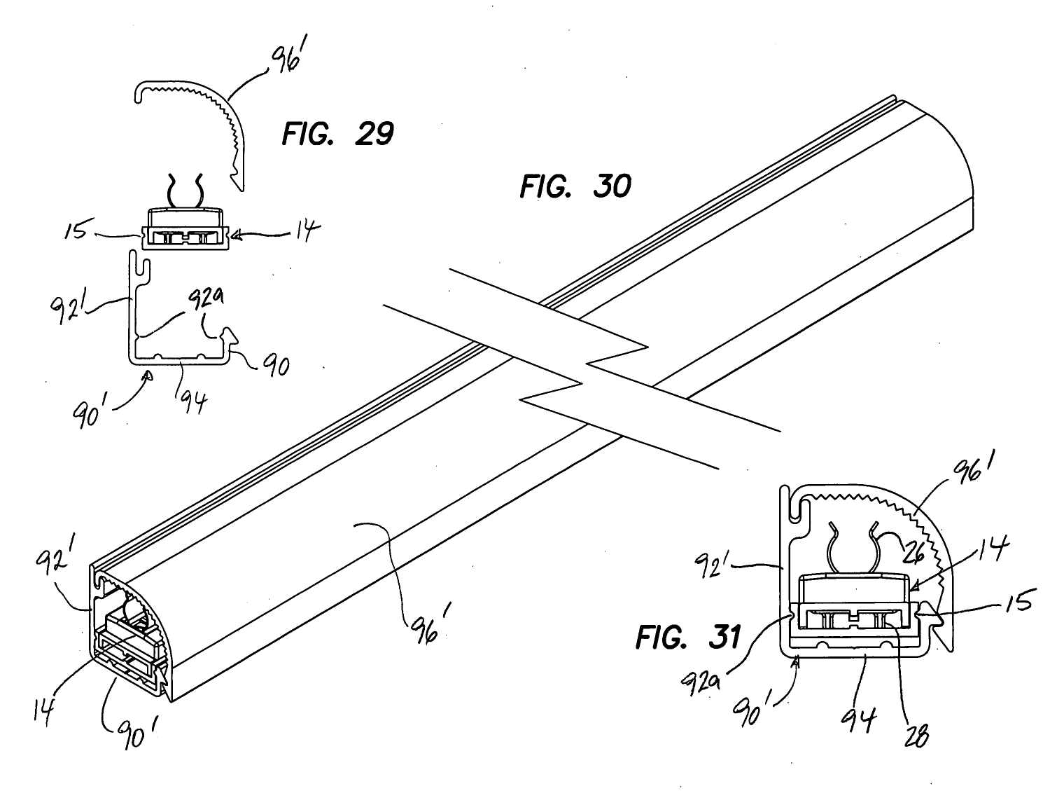

FIGS. 29-31 show an alternate track configuration 90′ suitable for mounting along a wall for a wall light wash effect. Track 90′ differs from track 90 in that one of the side walls 92 is taller than the other side wall and the lens 96′ covers a 90° arc in cross section rather than approximately a 180° arc as in lens 96 of FIG. 28.

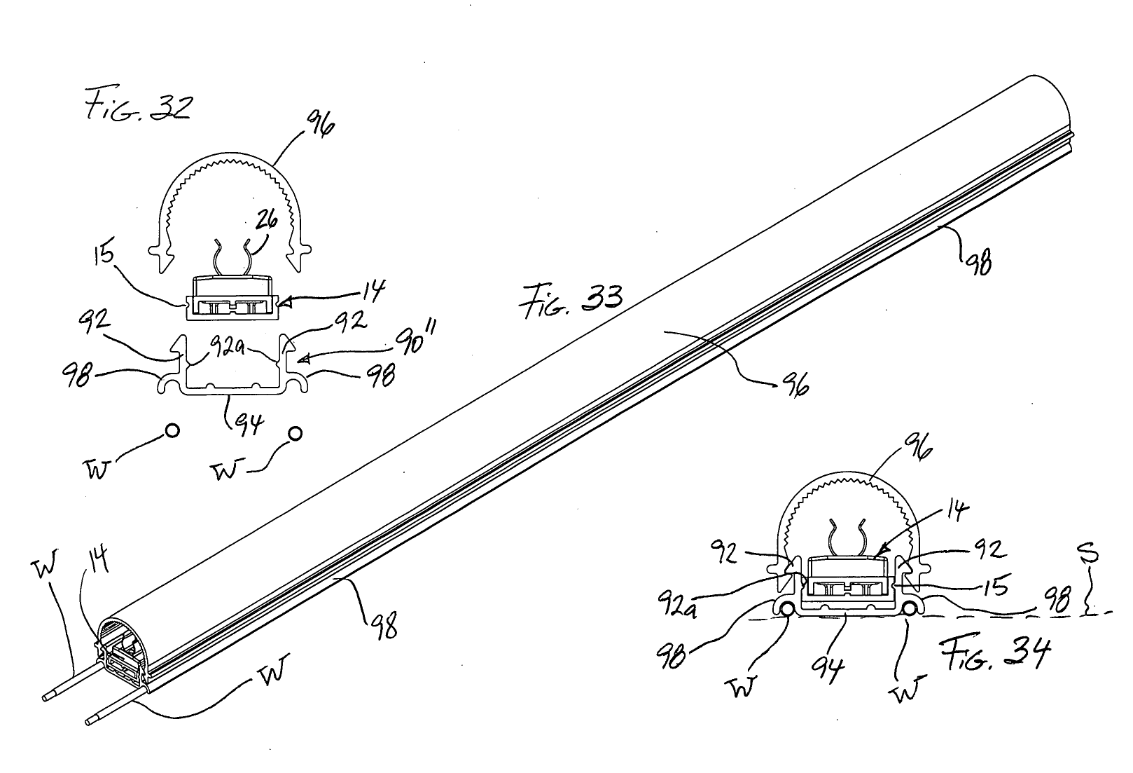

FIGS. 32-34 show a chaser type track 90″ similar to track 90 but provided with a chaser wire guide 98 on an outer side of each of the side walls 92 for guiding power supply chaser wires W along the outside of the track. The wire guides 98 are formed integrally with the track 90″, for example, as integral part of a track extrusion. The chaser wire guides 98 have an arcuate, generally quarter circular cross section with a concave underside 98a, generally conforming to the cross sectional curvature of an insulated electrical chaser wire W, for holding and containing the wire under the wire guide 98 and against a mounting surface S underlying the track bottom 94. The chaser type track 90″ is typically used in lighting installations where two consecutive track sections are powered by separate power transformers but both transformers are mounted at one end of track 90″. A first power transformer supplies power to cable 12 of chaser track 90″ and the exterior chaser wires carry electrical power from the second power transformer along track 90″ to the second section of track which starts at the opposite end of the chaser track 90″, where the exterior wires are connected to a cable 12 contained in the second section of track. This arrangement becomes necessary where the first section of track consumes the rated power output of one transformer and a second transformer is needed to power the second track section, but where for esthetic or practical considerations it is desirable to mount both transformers in one location at one end of the two continuous tracks.

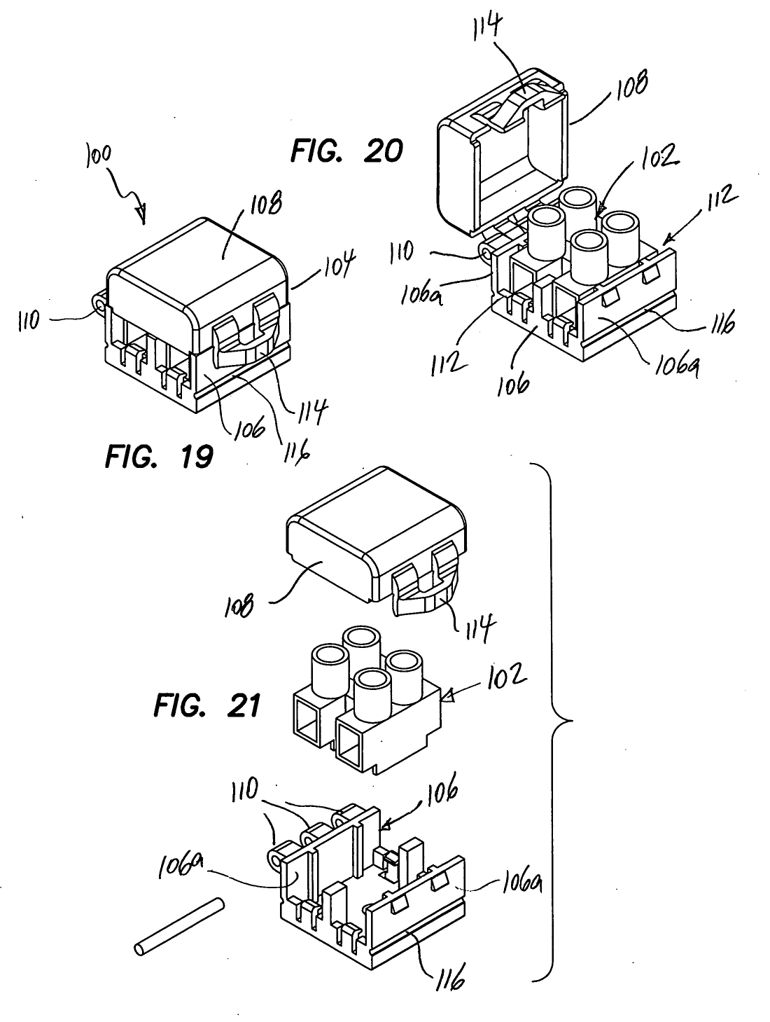

FIGS. 19-21 show a power block 100 where a conventional four-terminal screw-down terminal strip 102 is provided with a terminal strip housing 104. Housing 104 has a housing bottom 106 containing the terminal strip 102 and a housing cover 108 hinged at 110 to housing bottom 106. The housing bottom 106 has two housing bottom side walls 106a and two open ends 112 between side walls 106a. A clasp 114 is provided for fastening the housing cover 108 closed to housing bottom 106 as in FIG. 19. A pair of grooves 116 along the exterior of housing bottom side walls 106a are provided for making retentive engagement with side ridges 92a of track 90 so that the power block 100 can be snap mounted into the track 90 in a manner similar to the lamp sockets 14, as explained above. The power block 100 is used for making electrical power connections to and from power cable 12. One end of cable 12 is stripped to expose conductors 16 and each conductor 16 is inserted into a corresponding terminal on one open end 112 of power block 100. The conductors are fastened by tightening the corresponding two terminal screws of terminal strip 102. Two other wires, for example, two power carrying wires from a power transformer are inserted in the other two terminals on the opposite open end 112 and fastened there with the other two terminal screws. Terminal strip 102 is a commonly available item and its details are not shown in the drawings for simplicity.

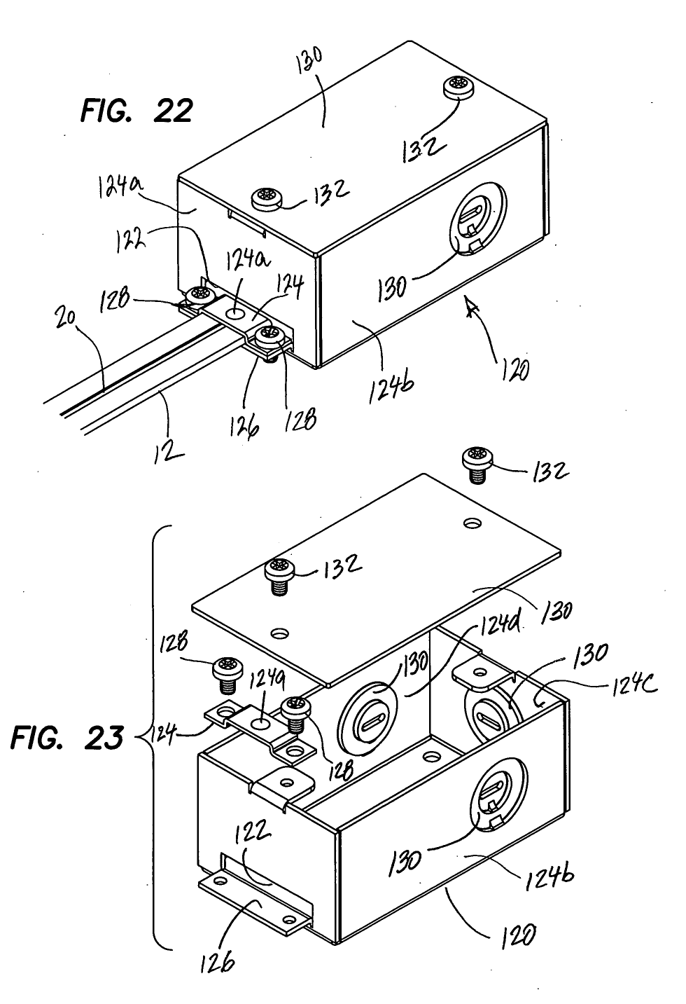

FIGS. 22-23 show a junction box 120 used to splice electrical wires to cable 12. Box 120 has a slot 122 in one side 124a of the box for admitting and end of power cable 12. Cable 12 is clamped to the box between clamping bar 124 and lip 126 of the box 120. A dimple 124a in the clamping bar is pressed down against the cable insulation by clamp screws 128 threaded for urging the clamping bar 124 against lip 126. The junction box 120 has knockouts 130 in each of the three remaining sides 124b,c,d of the box for admitting electrical wires to be spliced to the end of cable 12 in the box. The box is closed by a box cover 130 fastened with two screws 132.

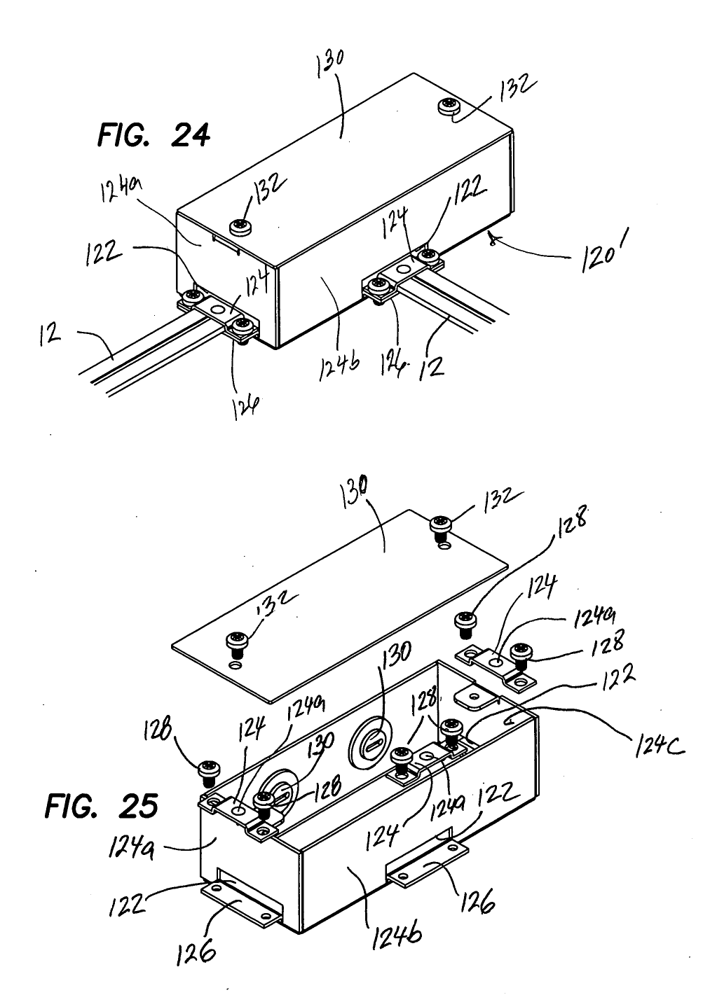

FIGS. 24-25 show another junction box 120′, where elements similar to those of box 120 in FIGS. 22-23 are designated by similar numerals. Box 120′ is provided with three cable slots 122 in three box sides 124′a,b,c for admitting one, two or three cable 12 ends into the box. Each cable slot 122 is provided with a corresponding cable clamping arrangement analogous to that described in connection with FIGS. 22-23 and designated by similar numerals. Box 120 is useful, for example, for making L or T junctions between two or three cables 12 and for connecting electrical supply wires admitted-through knockouts 130 to such junctions.

While particular embodiments of the invention have been explained and illustrated for purposes of clarity and example, it must be understood that many changes, modifications and substitutions will become apparent to those having only ordinary skill in the art without thereby departing form the scope of the invention.

What is claimed is:

1. A power cable and lamp socket assembly for an electric lighting system comprising:
a power distribution cable having two braided conductors in an insulating jacket; and
a plurality of lamp sockets spaced along said cable and in electrical contact with said conductors for supplying electrical power to a lamp installed in each of said sockets;
wherein said cable has a generally rectangular cable cross section with a width and a thickness and said width is substantially greater than said thickness and said cable is pliable such that said cable can be folded over a relatively short cable length between adjacent ones of said lamp sockets to make a right angle turn while keeping said cable substantially flat on a common plane at said adjacent ones of said lamp sockets on either side of said right angle turn.

2. The assembly of claim 1 wherein said cable is folded over itself along a diagonal fold line generally parallel to said common plane.

3. The assembly of claim 1 wherein said cable is twisted from a flat condition on either side of said right angle turn through approximately a forty five degree angle to a fold line contained in a plane transverse to said common plane.

4. The assembly of claim 1 wherein said braided conductors each have a generally rectangular conductor cross section.

5. The assembly of claim 4 wherein said braided conductors are flat rope braided comprising multiple braids each having multiple strands.

6. The assembly of claim 1 wherein each conductor has about seven braids of about twenty four strands each.

7. The assembly of claim 4 wherein said conductors are each braided with about 168 strands.

8. The assembly of claim 1 wherein said cable width is about 0.600 inch and said cable height is about 0.1 inch.

9. The assembly of claim 1 wherein said insulating jacket is of polyvinylchloride.

10. The assembly of claim 1 wherein said insulating jacket has a cable top and a cable bottom and a longitudinal slot of generally rectangular cross section in each of said top and said bottom between said conductors.

11. The assembly of claim 1 wherein said sockets are regularly spaced along said cable.

12. The assembly of claim 11 wherein said sockets are spaced by 3 inches from each other along said cable.

13. The assembly of claim 11 wherein said sockets are spaced by 6 inches from each other along said cable.

14. The assembly of claim 1 wherein each of said lamp sockets has a socket top and a socket bottom adapted to make interlocking engagement with each other for capturing said cable therebetween, and lamp contacts supported on said socket top and having piercing prongs projecting beneath said socket top for penetrating said insulating jacket and making electrical contact with said parallel conductors.

15. The assembly of claim 14 wherein said lamp contacts are adapted and configured for receiving the opposite end contacts of a festoon type double ended lamp with a lamp axis between said end contacts substantially parallel to said cable.

16. The assembly of claim 14 wherein said socket top is molded of thermoplastic material with two integrally formed contact clip holders for receiving and supporting said lamp contacts and a heat shield retained to said socket top between said clip holders.

17. The assembly of claim 16 wherein said heat shield is a metal plate retained by top prongs integral with said socket top.

18. The assembly of claim 16 further comprising a light reflector interchangeable with said heat shield on said socket top.

19. The assembly of claim 18 wherein said light reflector is a generally parabolic reflector.

20. The assembly of claim 18 wherein said reflector is curved only in a direction transverse to said lamp socket and is selectively weakened along break away lines for facilitating separation of either of two reflector wings from a reflector center, said reflector center being retained to said socket top by said top prongs.

21. The assembly of claim 14 wherein said socket top and socket bottom each have a center boss shaped to mate into a center slot in each of said cable top and said cable bottom respectively.

22. The assembly of claim 14 wherein said socket bottom has two socket sides and said socket top is seated onto said socket bottom between said socket sides and is fastened thereto by interlocking portions integral to said socket top and said socket bottom.

23. The assembly of claim 1 or claim 14 further comprising a mounting lug adapted to make snap retentive engagement with each said lamp socket, and a hole in said lug for passing a fastener therethrough such that each said lamp socket may be secured to a mounting surface by a fastener passing through said hole in said lug.

24. The assembly of claim 14 wherein said lamp contacts are configured for receiving a festoon type lamp with festoon contacts at opposite ends of a generally cylindrical lamp body and further comprising an adapter for installing an MR type lamp having parallel pin contacts in said lamp socket, said adapter comprising:
a frame having a longitudinal axis and a transverse axis, a frame supported between festoon contacts along said longitudinal axis, a lamp holder, a pair of conductive clip inserts fitted in clip receptacles defined in said lamp holder, pin holes in said lamp holder communicating said clip receptacles to a lamp seat surface on said lamp holder such that lamp pins inserted in said pin holes come into electrical contact with said clip inserts, said clip inserts supporting said frame to said frame for pivotal movement about said transverse axis, and electrical connectors on said frame for interconnecting each said clip insert to a corresponding one of said festoon contacts, whereby electrical power is provided from said festoon contacts to lamp pins inserted in said pin holes

25. The assembly of claim 24 wherein said clip inserts are pivotable about a first pair of conductive rivets supported on said frame, said festoon contacts are fastened to said frame by a second pair of conductive rivets, and said electrical conductors comprise conductive strips between said first rivets and said second rivets.

26. The assembly of claim 24 wherein said lamp holder is generally tubular and said clip receptacles are opposite ends of a bore through said lamp holder.

27. The assembly of claim 24 further comprising a centrally apertured dished light shield having a rearwardly extending axial collar about said central aperture and a generally U-shaped clip fitted about said lamp holder and having clip ends in releasable retentive engagement with said collar for attaching the collar to said lamp holder such that a lamp may be inserted through said collar into said pin holes without separating the shield from the lamp holder.

28. The assembly of claim 27 wherein said collar is integrally formed with said dished light shield and said collar has diametrically opposed openings stamped out for admitting said clip ends into said retentive engagement.

29. The assembly of claim 1 further comprising an end cap for terminating said power distribution cable, comprising a cap top and a cap bottom assembled to each other in releasable interlocking engagement for capturing therebetween an end of said power distribution cable,

30. The assembly of claim 29 wherein each of said cap top and said cap bottom have three sides and an open side, said three sides of said cap top are received between said three sides of said cap bottom in said assembled condition.

31. The assembly of claim 29 further comprising a mounting lug adapted to make snap retentive engagement with said end cap and a hole in said lug such that the end cap may be secured to a mounting surface by a fastener passing through said hole in said lug

32. The assembly of claim 30 further comprising a mounting lug adapted to make snap retentive engagement with said end cap and a hole in said lug such that the end cap may be secured to a mounting surface by a fastener passing through said hole in said lug, wherein said lug has prongs engageable in a slot defined in said cap bottom for making said snap retentive engagement with said cap.

33. The assembly of claim 29 wherein said cap bottom has two cap bottom sides and said cap top is seated onto said cap bottom between said cap bottom sides and is fastened thereto by interlocking portions integral to said cap top and said cap bottom.

34. The assembly of claim 33 wherein said interlocking portions integral to said cap top and said cap bottom Include a plurality of tabs on said cap top engageable in corresponding tab slots defined in said cap bottom.

35. The assembly of claim 29 wherein said cap top and cap bottom each have center ridges configured to mate into a center slot in said cable top and said cable bottom respectively.

36. The assembly of claim 1 further comprising a mounting clip for supporting said power distribution cable to a mounting surface, said clip comprising a clip plate having a contact side for placement against a mounting surface, at least one clip arm on an opposite side of said clip plate, and a hole for passing a mounting fastener through said plate.

37. The assembly of claim 36 further comprising an adhesive on said contact side for initially holding the clip to a mounting surface to facilitate installation of a screw fastener or the like through said plate and into the mounting surface.

38. The assembly of claim 1 further comprising a substantially rigid track with two track sides and a track bottom, a side ridge along each said track side, said lamp socket having side grooves adapted to receive said side ridges such that said lamp socket can be pressed into said track between said track sides and is retained therein by engagement of said side ridges in said side grooves.

39. The assembly of claim 38 further comprising a translucent or transparent lens assembled over said track.

40. A power cable having a pair of conductors in an insulating jacket, said insulating jacket having a generally rectangular cross section with a cable width and a cable height smaller than said cable width, a cable top and a cable bottom, said conductors each having a rectangular cross section with a conductor width and a conductor height smaller than said conductor width, said conductor width being transverse to said cable height, and a longitudinal slot centered in each of said cable top and said cable bottom.

41. The power cable of claim 40 wherein said longitudinal slot is of rectangular cross section with a slot bottom between parallel slot walls.

42. The power cable of claim 40 wherein said conductors are flat rope braided comprising multiple braids each having multiple strands.

43. The power cable of claim 42 wherein each said conductor has about seven braids of about twenty four strands each.

44. The power cable of claim 40 wherein said conductors are each braided with about 168 strands.

45. The power cable of claim 44 wherein said strands are 0.005 inch copper strands.

46. The power cable of claim 40 wherein said conductors width and said conductor height are approximately 0.1350 inch and 0.05 inch respectively.

47. The power cable of claim 40 wherein said cable has a current rating of 30 amperes.

48. The power cable of claim 40 wherein said conductors have an electrical resistance generally similar to that of AWG 10 stranded wire.

49. The power cable of claim 40 wherein said cable has two electrical conductors of braided copper strands and each conductor is of rectangular cross section with a conductor height smaller than a conductor width.

50. An electric lighting system comprising:
a power distribution cable having two braided conductors in an insulating jacket; and
a plurality of lamp sockets spaced along said cable wherein each of said lamp sockets has a socket top and a socket bottom adapted to make interlocking engagement with each other for capturing said cable therebetween, and lamp contacts supported on said socket top and having piercing prongs projecting beneath said socket top for penetrating said insulating jacket and making electrical contact with said parallel conductors;
a mounting lug adapted to make retentive engagement with said socket bottom and a fastener for securing said lug to a mounting surface; and
a track shaped for retentively receiving said socket bottom and fasteners for securing the track to a mounting surface;
such that any one of said lamp sockets can be Installed on a mounting surface either with said mounting lug or in said track.

51. The system of claim 50 wherein said mounting lug has a hole therein for passing said fastener therethrough.

52. The system of claim 50 wherein said socket bottom has two opposite socket sides and said socket top is received between said socket sides.

53. The system of claim 52 wherein said cable has a generally rectangular cross section with a cable top and a cable bottom and a longitudinal slot of generally rectangular cross section in each of said top and said bottom between said conductors, and wherein said socket top and socket bottom each have a center boss shaped to mate into said longitudinal slot in said cable top and said cable bottom respectively.

54. The system of claim 50 further comprising an end cap for terminating a cable end of said cable, said cap having a cap top and a cap bottom assembled to each other in releasable interlocking engagement for capturing therebetween said cable end, said cap bottom being configured to accept a said mounting lug or alternatively to snap into said track for installation on the said mounting surface

55. The system of claim 54 wherein said cap top and said cap bottom each have three sides and an open side, and said three sides of said cap top are received between said three sides of said cap bottom in said assembled condition.

56. The system of claim 54 wherein said mounting lug is adapted to make snap retentive engagement with said end cap and a hole in said lug such that the end cap may be secured to a mounting surface by a fastener passing through said hole In said lug, and wherein said lug has prongs engageable in a slot defined in said cap bottom for making said snap retentive engagement with said cap.

57. The system of claim 54 wherein said cap bottom has two cap bottom sides and said cap top is seated onto said cap bottom between said cap bottom sides and is fastened thereto by interlocking portions integral to said cap top and said cap bottom.

58. The system of claim 57 wherein said interlocking portions integral to said cap top and said cap bottom include a plurality of tabs on said cap top engageable in corresponding tab slots defined in said cap bottom.

59. The system of claim 54 wherein said cap top and cap bottom each have center ridges configured to mate into a center slot in said cable top and said cable bottom respectively.

60. The system of claim 50 further comprising a terminal strip housing configured for making retentive engagement in said track and:a terminal strip in said housing for interconnecting said power distribution cable to power supply wiring.

61. In a lamp holder for receiving a lamp with an integral light reflector, a centrally apertured dished light shield having a rearwardly extending axial collar about said central aperture and a generally U-shaped clip fitted about said lamp holder and having clip ends in releasable retentive engagement with said collar for attaching the collar to said lamp holder such that a lamp may be inserted through said collar into said pin holes without separating the shield from the lamp holder.

62. The system of claim 50 wherein said track has a pair of side walls and a track bottom, a wire guide on an outer side of each of said side walls for guiding power supply wires along the outside of said track.

63. The system of claim 50 wherein said wire guides are integral with said track.

64. The system of claim 62 wherein said wire guides are shaped for each containing an electrical wire against a mounting surface underlying said track bottom.

65. A low profile track lighting system comprising a track having two track side walls and a track bottom between said side walls, a power distribution cable having a generally rectangular cross sectional shape including a cable width and a cable height, a plurality of lamp sockets each having a socket top and a socket bottom adapted to make interlocking engagement with each other for capturing said cable therebetween, and lamp contacts supported on said socket top and having piercing prongs projecting beneath said socket top for penetrating said insulating jacket and making electrical contact with said parallel conductors, said socket bottom having opposite socket bottom side walls, said socket being contained between said socket bottom side walls, said socket bottom being configured for making retentive engagement with said track side walls.

66. The low profile track of claim 65 wherein said cable has a longitudinal slot of rectangular cross section in each of said cable top and said cable bottom and said socket top and said socket bottom each have a longitudinal boss of rectangular cross section shaped to mate into a corresponding said longitudinal slot of said cable.

67. The system of claim 65 wherein said track has a pair of side walls and a track bottom, a wire guide on an outer side of each of said side walls for guiding power supply wires along the outside of said track, said wire guides being integral with said track and shaped for each containing an electrical wire against a mounting surface underlying said track bottom.

68. The system of claim 67 wherein said cable has two electrical conductors of braided copper strands and each conductor is of rectangular cross section with a conductor height smaller than a conductor width.
